(19) United States
(12) Patent Application Publication
(10) Pub. No.: US 2007/0251281 A1
(43) Pub. Date: Nov. 1, 2007

(54) Trailer locking system

(76) Inventor: Johnny S. Palmire, San Antonio, TX (US)

Correspondence Address: Johnny S. Palmire, 14934 Gateview Dr., San Antonio, TX, 78248, US

(21) Appl. No.: 11/415,341

(22) Filed: May 1, 2006

(51) Int. Cl. E05B 65/12

(52) U.S. Cl. 70/258

(57) ABSTRACT

A trailer locking system is disclosed that is adapted to be used to hold the hitch of a trailer in a position jacked above a height at which the trailer can be hitched to a vehicle therefore preventing the theft of the trailer. The locking system comprises an elongated locking shaft, an L-shaped support bracket adapted to receive the locking shaft and having at least one brace slot, a generally flat mounting brace adapted to fit through the at least one brace slot and adapted to receive the locking shaft, and a locking pin adapted to fit through a locking pin hole in the locking shaft and adapted to receive a lock when inserted through the locking shaft.

### BACKGROUND OF THE INVENTION

1. Field of the Invention

The field on the invention relates generally to locks, and more particularly to anti-theft systems for trailers.

2. Description of the Related Art

Trailers are used for hauling all sorts of equipment and materials. Trailers range from very simple and relatively inexpensive to very complex and expensive in order to provide the functionality and capacity for the task required of each particular trailer. It is not uncommon, unfortunately, for trailers to be stolen. It is also relatively easy to steal trailers. In many instances, a thief merely attaches a trailer to be stolen to his truck and drives off with it.

Current methods of securing trailers against theft include using locks on the trailer hitch to prevent hitching of the trailer to a towing vehicle. However, it has been found that such locks can be knocked off the trailer's hitch with heavy hammers relatively simply. Another securing mechanism is a wheel lock, known as a boot, which fits over a tire of the trailer and prevents the tire from rotating. Wheel locks are not very adaptable for various size tires necessitating the manufacture of multiple different products by manufactures, which increases the manufacturing cost for each device. This also requires vendors to stock many different sizes of such locks, taking up valuable retail space and again leading to a relatively higher cost per unit.

Therefore, there is a need for a system for securing trailers that is both difficult for thieves to defeat and adaptable to many different sizes and styles of trailers.

### SUMMARY OF THE INVENTION

The systems and methods have several features, no single one of which is solely responsible for its desirable attributes. Without limiting the scope as expressed by the claims that follow, its more prominent features will now be discussed briefly.

After considering this discussion, and particularly after reading the section entitled “Detailed Description of the Preferred Embodiments” one will understand how the features of the system and methods provide several advantages over traditional systems and methods.

In one embodiment a trailer locking system for a trailer is described comprising a vertical shaft, a locking bracket; and a lock adapted to engage the vertical shaft and the locking bracket, wherein the locking bracket and lock are adapted to engage the locking shaft to affix the locking shaft to the trailer at a vertical height that renders the trailer harder to tow.

In some aspects the trailer locking system the vertical shaft comprises at least one locking hole. In another aspect, the vertical shaft further comprises a plurality of locking holes adapted to correspond to different locking heights of the trailer. The locking bracket of some embodiment further comprises an L-shaped support bracket and a mounting brace.

In another embodiment, a locking mechanism for a trailer is described comprising, a retaining bracket attached to the trailer, thereby forming a substantially vertical opening, and a locking shaft adapted to fit in the opening formed by the bracket and the trailer, wherein the bracket and the locking shaft each have holes formed therein to accept a lock to affix the locking shaft within the opening. In some such embodiments, the mounting brace is substantially U-shaped and the locking shaft is substantially an elongated square tube. In some aspects, the lock consists of a locking pin and a receiving lock.

In another aspect, a method for preventing the theft of a trailer having a towing hitch and frame is described, the method comprising the steps of attaching a bracket to the frame, inserting a locking shaft through a substantially hole in the bracket, and locking the locking shaft to the bracket such that the locking shaft cannot move vertically with respect to the bracket. In some aspects of the method, the attaching step further comprises welding the bracket to the frame. In yet other aspects, the locking step is performed using a receiving lock

These and other improvements will become apparent to those skilled in the art as upon a reading of the following detailed description and the enclosed figures.

### BRIEF DESCRIPTION OF THE DRAWINGS

FIG. 1 is a side elevation view of one embodiment of a trailer locking system installed on a trailer.

FIG. 2 is a perspective view of the trailer locking system of one embodiment installed on a trailer.

FIG. 2A is a partial side view of one embodiment of a trailer locking system.

FIG. 3 is a perspective view of the assembled trailer locking system of FIG. 1.

FIG. 4 is a side view of a locking shaft of the trailer locking system of FIG. 3.

FIG. 5 is a bottom view of the locking shaft of FIG. 4.

FIG. 6 is a front view of the locking shaft of FIG. 4.

FIG. 7 is a side view of a support bracket of the trailer locking system of FIG. 3.

FIG. 8 is a partial front perspective view of the support bracket of FIG. 7.

FIG. 9 is a partial top perspective view of the support bracket of FIG. 7.

FIG. 10 is a top perspective view of a mounting brace of one embodiment of a trailer locking system.

FIG. 11 is a side view of the mounting brace of FIG. 10.

FIG. 12 is a side view of an alternative embodiment of the mounting brace of FIG. 11.

FIG. 13 is a side view of a locking pin of the trailer locking system of FIG. 3.

FIG. 14 is a top view of the locking pin of FIG. 13.

FIG. 15 is a front view of a locking bracket of an alternative embodiment of a trailer locking system.

FIG. 16 is a top view of the locking bracket of FIG. 15.

FIG. 17 is an alternative embodiment of a locking shaft.

FIG. 18 is an alternative embodiment of the locking pin.

FIG. 19a is a top view of an alternative embodiment of the trailer locking brace of FIGS. 15 and 16.

FIG. 19b is a front elevation view of the trailer locking brace of FIG. 19a

### DETAILED DESCRIPTION OF THE PREFERRED EMBODIMENT

Embodiments of the invention will now be described with reference to the accompanying figures, wherein like numerals refer to like elements throughout. The terminology used in the description presented herein is not intended to be interpreted in any limited or restrictive manner simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

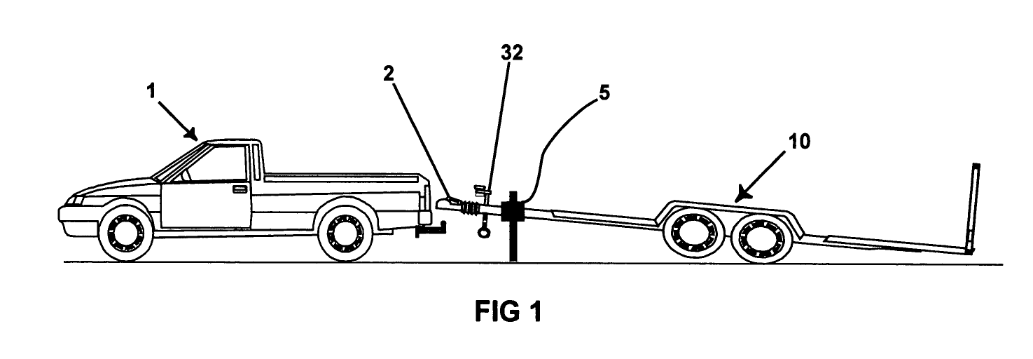

Referring to FIG. 1, a new style of a trailer locking system 5 is illustrated. A towing vehicle 1 tows a trailer 10 via a hitch 2. In existing locking systems the hitch 2 is locked to prevent hitching the trailer 10 to the vehicle 1. In the embodiments described herein a locking system 5 elevates the trailer 10 in the vicinity of the hitch 2. The trailer 10 is prevented from being properly hitched to the vehicle 1 by preventing the jack 32 from leaving the hitch. Furthermore, even if the trailer 10 is able to be hitched to vehicle 1, the locking system 5 causes interference for a thief as they try to tow the trailer 10 away.

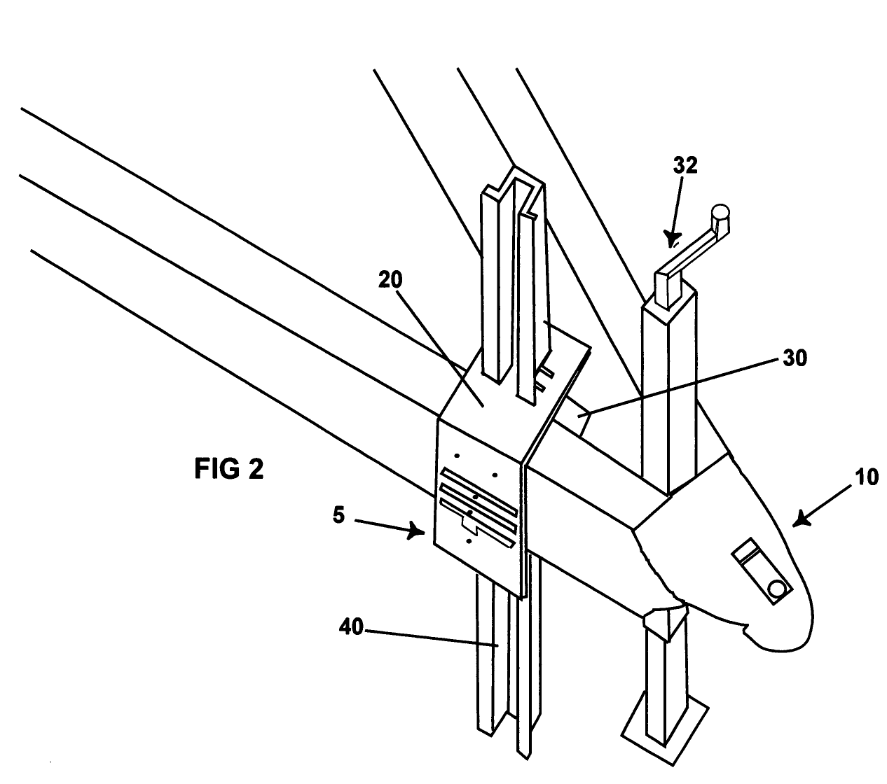

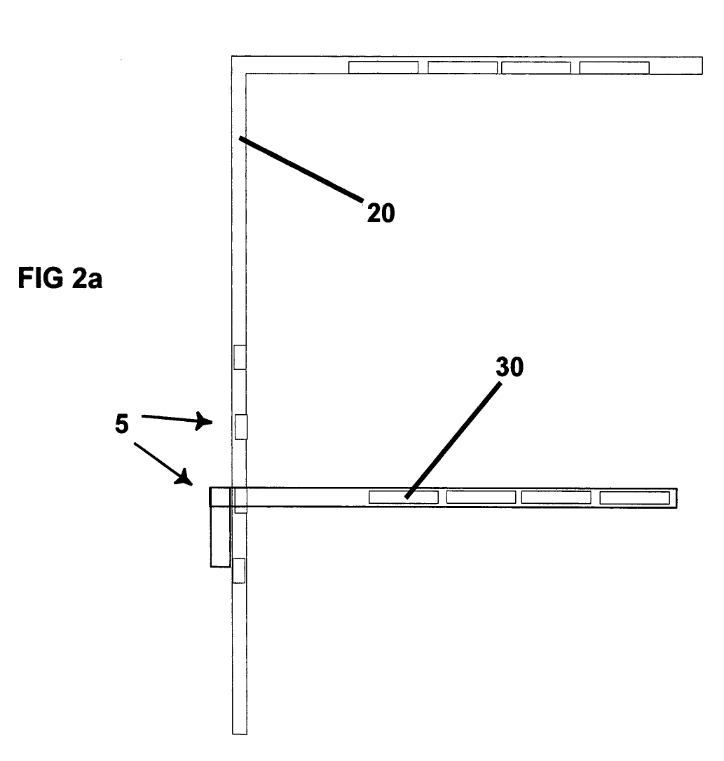

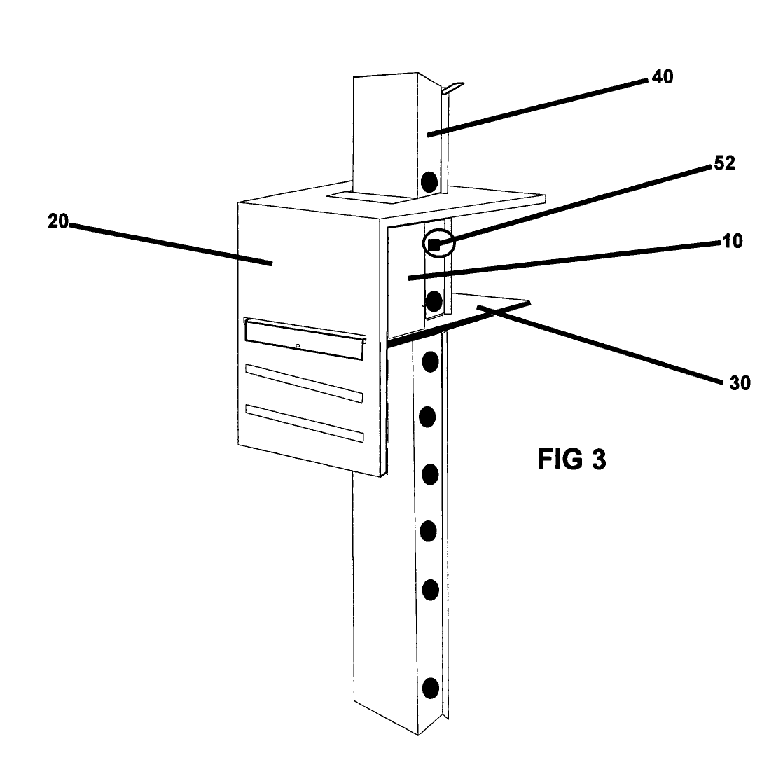

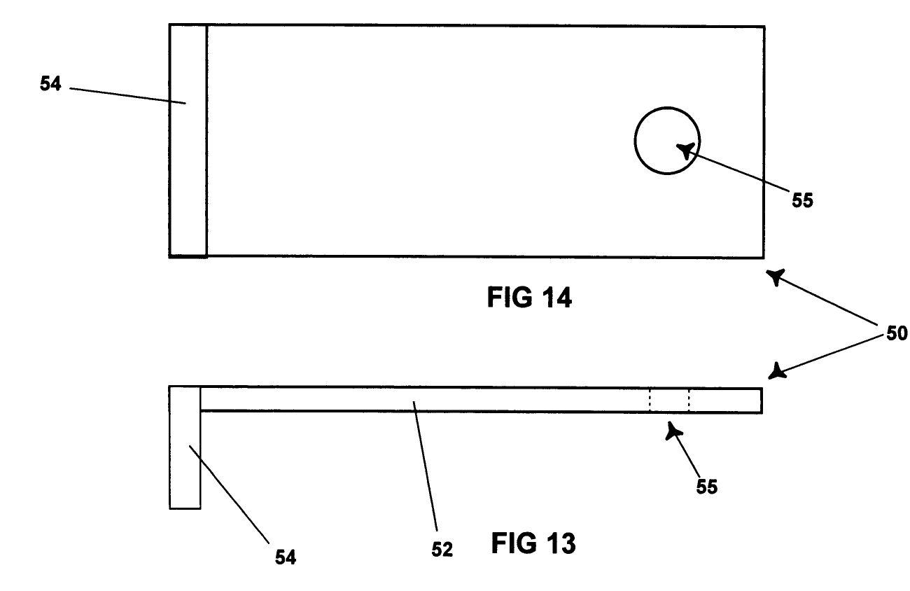

FIGS. 2, 2A, and 3 illustrate two embodiments of the trailer locking system 5. The trailer locking system 5 generally comprises a locking shaft 40 that provides the elevation for the trailer 10. The locking shaft 40 is held in place by a support bracket 20 and a mounting brace 30 around the frame of the trailer 10. As illustrated in 2A, the mounting brace 30 slides into the support bracket 20 to form a pocket for the frame of the trailer 10. The locking shaft 40 is then inserted through the support bracket 20 and the mounting brace 30 to enclose the frame member of the trailer 10. A locking pin 52 (also described below with respect to FIGS. 13 and 14) is then slid through the locking shaft 40 to maintain the height of the locking system 5.

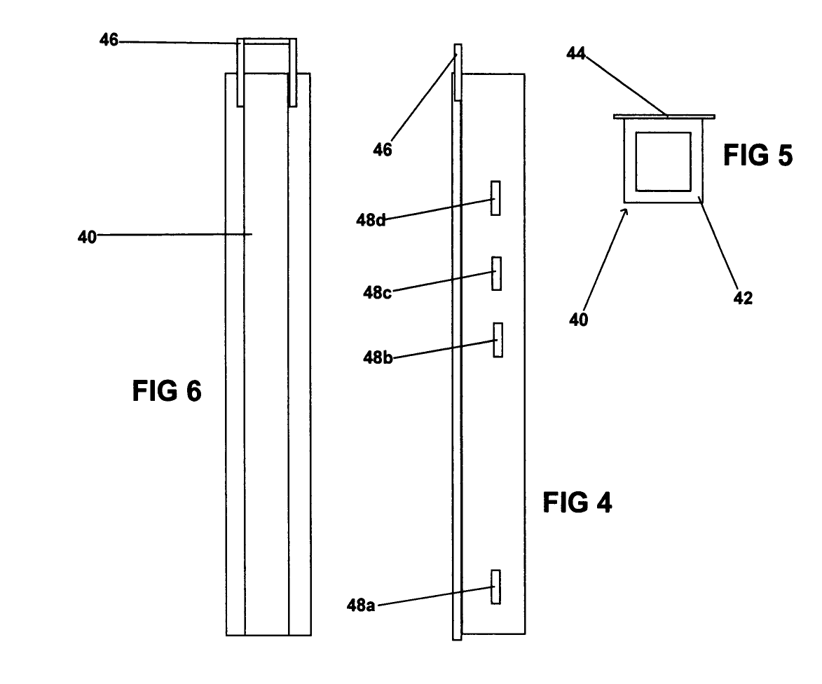

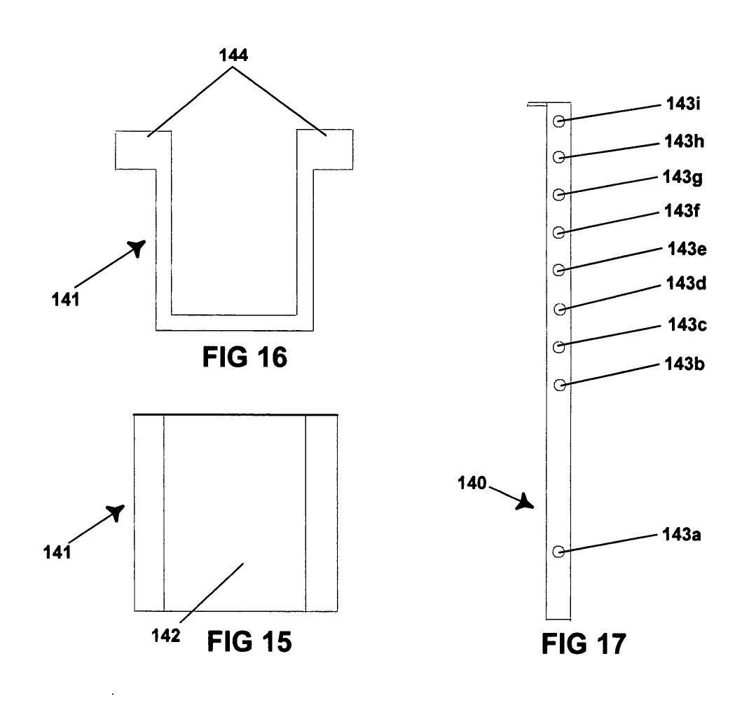

FIGS. 4, 5, and 6 illustrate the locking shaft 40 of one embodiment (FIGS. 15, 16 & 17 show another embodiment of locking shaft 40). The illustrated locking shaft 40 is generally an elongated shaft formed, in this embodiment, by a square extension 42, or elongated member, and a strip 44. In other embodiments, the extension 42 is not square but is some other shape including, but not limited to circular, oval, triangular or any other cross sectional shape. As illustrated in FIG. 2, the extension can be of various shapes such as U-shaped or other non-concentric shapes such as V-shaped or W-shaped. The shape of the extension 42 can aid in preventing the bending of the extension 42 in attempting to defeat the locking system 5. The strip 44 in the illustrated embodiment is attached to the tube 42 and is slightly wider than that tube 44, so that it extends on either side of the tube 42 forming tabs on either side of the tube 42. The strip 44 can be attached to the extension 42 by any means such as welding, fastening, adhesive or any other means. In some embodiments, the extension 42 and the strip 44 are formed as an integral unit and do not need to be attached. The locking shaft 40 can be made of any material including, for example only, metals such as steel, aluminum, carbon steel, stainless steel or any other metal, plastic or carbon fiber, or wood. In some embodiments materials of high structural strength are used to prevent bending or resist impact.

Still referring to FIGS. 4, 5, and 6, on one end of the locking shaft 40 a handle 46 is attached to the locking shaft 40 for easy carrying of the locking system. The handle 46 can be any form or structure enabling a user to easily grasp and carry the locking shaft 40 or the entire locking system 5 and the locking shaft 40. The locking shaft 40 of the illustrated embodiment also includes multiple locking slots 48a-d, although it is not limited t more or less slots. The locking pin (item 50 of FIGS. 13, 14 and 18) fits through one of the locking slots 48 in order to establish the height of the locking system 5. The varying height of the locking slots 48 allows the user to establish the height at which the trailer 10 will be locked in order to prevent theft. The lowest locking slot 48a can be used to lock the locking shaft 40 up in a stowage position for when the trailer 10 is going to be hitched for towing by the user.

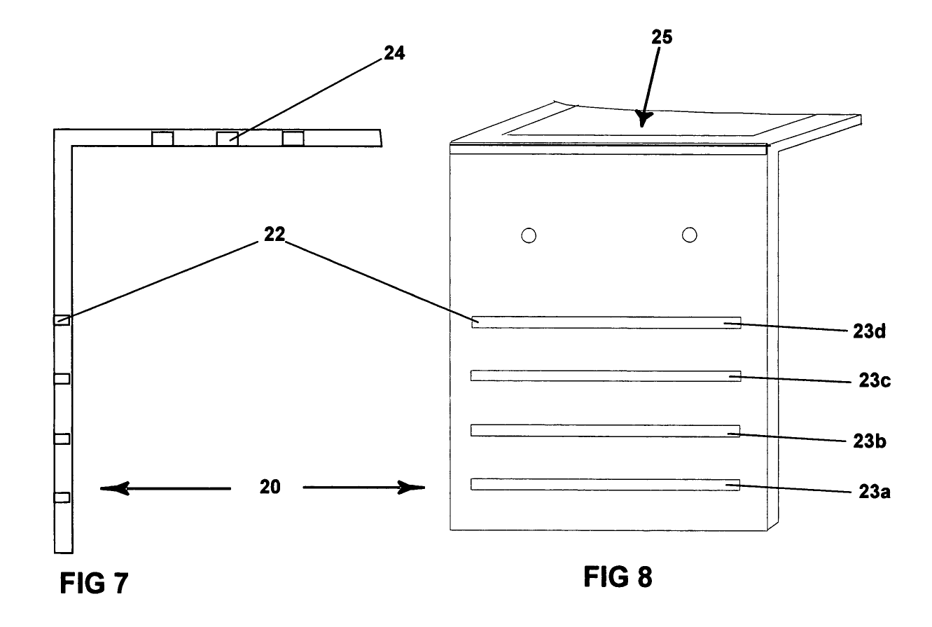

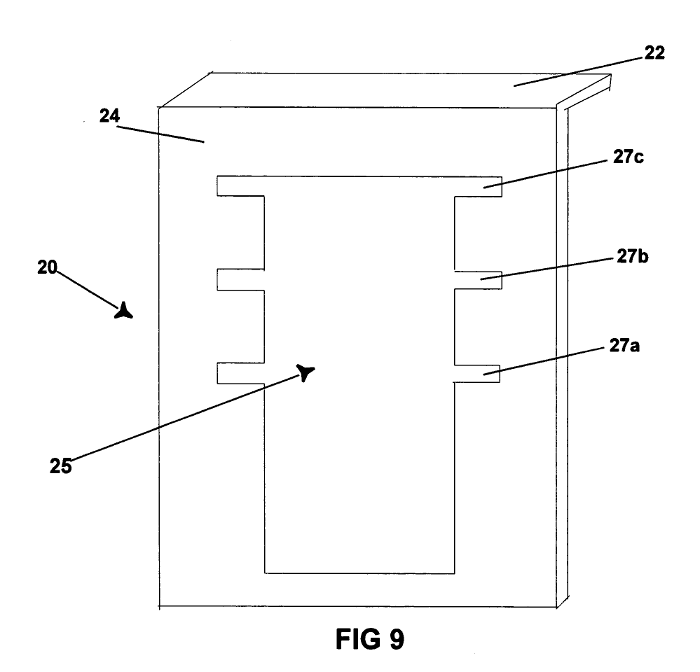

FIGS. 2, 2A, 3, 7, 8 and 9 illustrate one embodiment of a support bracket 20 of one embodiment. The illustrated support bracket 20 comprises a first slotted plate 22 and a second shaft plate 24. The slotted plate 22 and the shaft plate 24 of the illustrated embodiment are generally flat rectangular metal plates, but can be various forms as well, that are attached to one another at an end of each, at a generally right angle in the illustrated embodiment. The slotted plate 22 has one or more slots 23a-d each adapted to accept the mounting brace 30 and positioned to allow for a different frame size of the trailer 10. The shaft plate 24 of the illustrated embodiment has a shaft hole 25 for the passage of the locking shaft 40 with shaft slots 27a-c. The shaft slots 27 are shaped to fit the tabs formed by the strip 44 of the locking shaft 40. The distance of each shaft slot 27 from the slotted plate 22 allows insertion of the locking shaft 40 at a different distance from the slotted plate 22 allowing for different thickness of the frame member of the trailer 10. Shaft slot 27a allows for the largest frame member while shaft slots 27b and 27c allow for progressively smaller frame members. The shape of the shaft hole 25 and shaft slots 27 are adapted to accommodate a different shaped locking shaft 40. Similar to the locking shaft 40, the support bracket 20 can be made of any structural material such as metals, plastics, composites or wood. In some embodiments, high structural strength and impact resistance are desired properties for the material used.

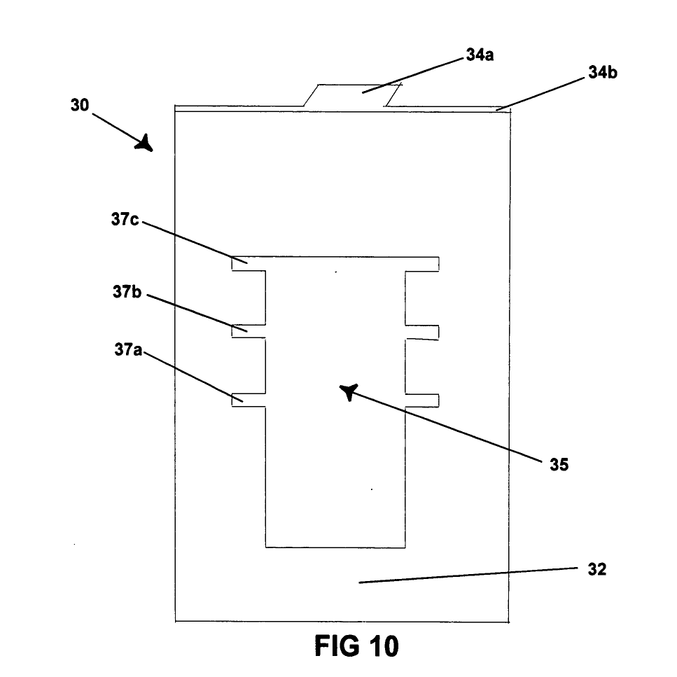

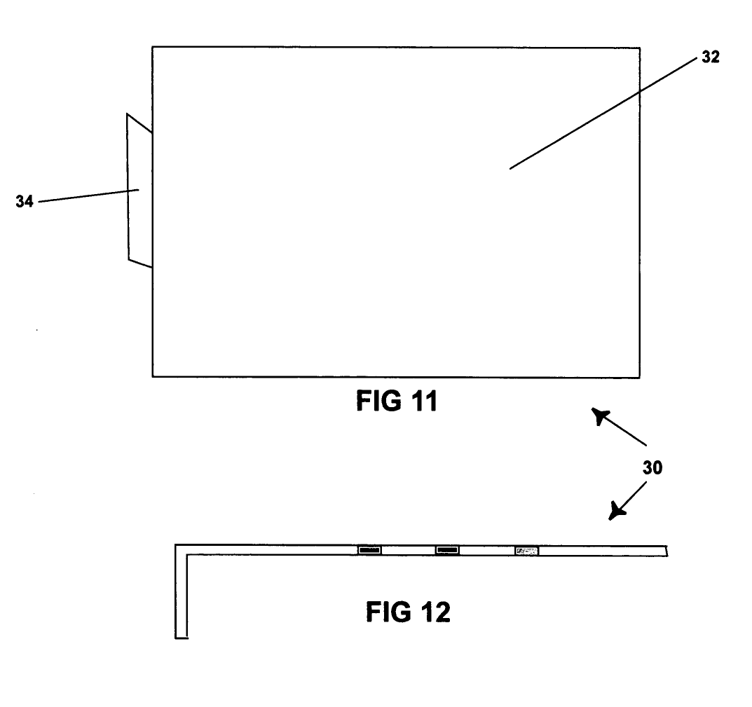

FIGS. 2, 2A, 3, 10 and 11 illustrate an embodiment of a mounting brace 30 of the locking system 5. The mounting brace 30 of this embodiment comprises a generally flat plate 32 with a tabbed end 34. The plate 32 has a plate hole 35 formed in it to pass the locking shaft 40, in a similar manner as described above for the shaft hole 25 in the support bracket 20. Mounting slots 37a-c are formed in the plate 32 as well and serve a similar function as the shaft slots 27 in the support bracket 20. The tabbed end 34 of the mounting brace 30 is an extension angling from the plate 32 and retains the mounting brace 30 in the slots 23 of the support plate 20. In the embodiment of FIGS. 11 and 12, the tabbed end 34 is split with one half going up and the half going down, however, as illustrated in FIGS. 2, 2A and 3, the tabbed end of other embodiments can be bent one way or the other. The mounting brace 30 can be made of any structural material in the same manner as the support bracket 20 or the locking shaft 40.

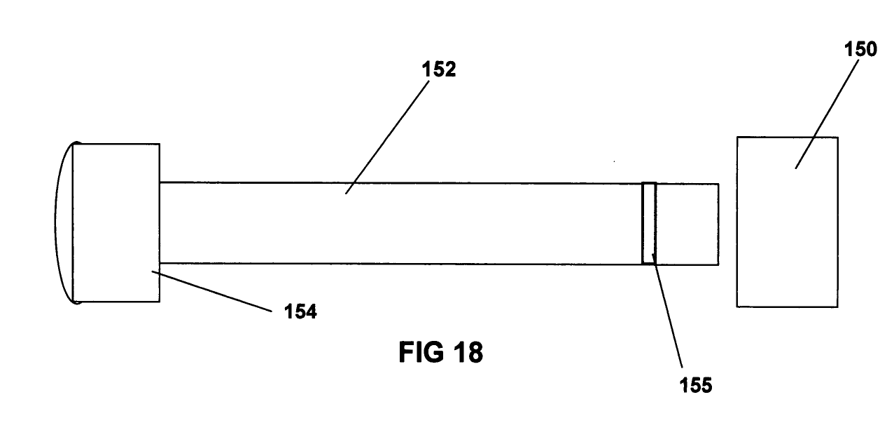

Referring now to FIGS. 13 and 14, an embodiment of a locking pin 50 is illustrated. The illustrated locking pin 50 is shaped in order to fit through the locking slots 48 of the locking shaft 40. The illustrated locking pin 50 has a flat elongated body 52 and a retainer 54 at one end and a lock hole 55 in the other. The retainer 54 is an extension from the body 52 that prevents the locking pin 50 from passing through the locking shaft 40 through one direction. The lock hole 55 extends from the other side of the locking pin 50 in the locking shaft 40 thereby securing the locking system 5 to the trailer 10. In various embodiments, the lock hole 55 and locking pin 50 are shaped such that any type of lock a user chooses can be used such as drawbar locks, trailer locks, u-bolt locks, receiver locks, coupling locks or any other suitable lock. In other embodiments, the locking pin 50 and the lock hole 55 are specifically designed for a particular style of lock or are integral with the lock (see FIG. 18).

Referring now to FIGS. 15, 16, and 17, an alternative embodiment of the locking system 5 is illustrated. In the illustrated embodiment, a frame brace 141 attaches to the frame of the trailer 10 and houses the locking shaft 140 of this embodiment. The frame brace 141 is a U-shaped body 142 with tow brace tabs 144, one running the length of each leg of the U. The tabs 144 are used for attaching the frame brace 141 to the frame of the trailer 10 to form a path and bracket for the locking shaft 140 of this embodiment. The locking shaft 140 of this embodiment is a square tube with one or more holes 143a-i for locking the shaft 140 in place. Again, the lowest hole 143a of some embodiments is utilized to secure the locking shaft 140 for travel while the other holes 143b, c can be used to support the trailer hitch at different heights when the trailer locking system 5 is engaged. The holes 143 can be shaped such that a lock can be placed through the frame brace 141 and the locking shaft 140 or they can be shaped to allow a locking pin 50 to be inserted through the frame brace 141 and the locking shaft 140 as in the other embodiments described herein. The illustrated embodiment of the frame brace 141 is U-shaped and the locking shaft 140 is a conforming square tube, however other embodiments utilize differently shaped cross sections of the locking shaft 140 such as round, oval, triangle, W-shaped or any other shape and the frame brace 141 of such embodiments is a conforming shape. In such embodiments, the shapes aid in ease of manufacturing or in stronger resistance to impact or bending and the choice of shapes depends upon the particular type of trailer being used and the types of forces the locking system 5 of those embodiments will encounter. Again, the parts of these embodiments can be made of any material such as any metal (such as for example steel, aluminum, carbon steel, stainless steel or any other metal), plastics or wood as the designer chooses based upon the strength required and the cost of the device.

FIG. 18 illustrates another embodiment of an integral locking pin 50 and 150 lock. In this embodiment, the locking pin 50 comprises an elongated lock rod 152 that is a generally elongated rod. A retaining stop 154 is attached to one end of the lock rod 152 and the other end has a locking edge 155. A lock 150 is used that receives and corresponds to the locking edge 155 of the locking pin 50 and can alternatively retain the locking pin 50 when engaged or release the locking pin 50 when disengaged. This locking pin 50 and lock 150 can be used in many embodiments herein either with the existing locking pins 50 of those embodiments or instead of them.

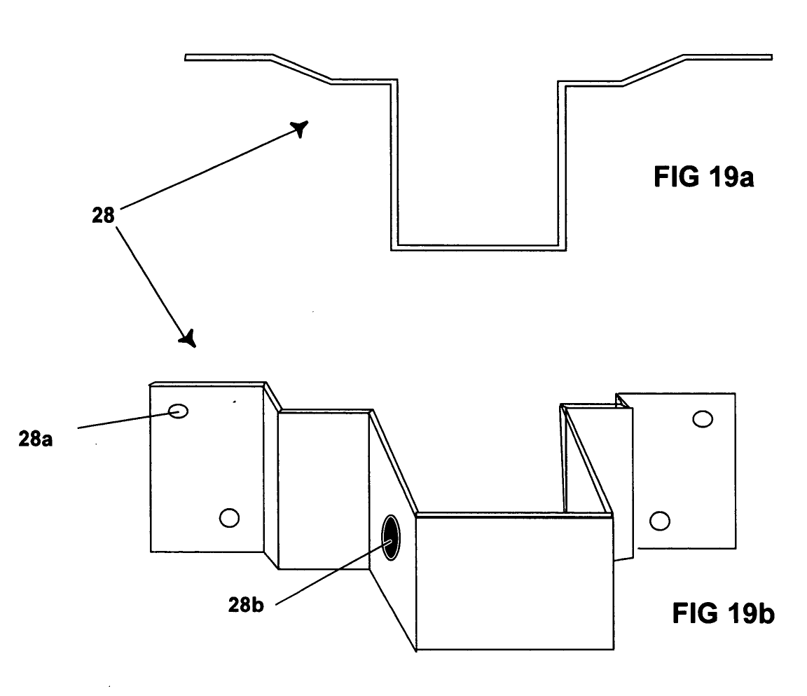

FIGS. 19a and 19b illustrate trailer bracket 28 that is an alternative embodiment of the trailer bracket 141 illustrated in FIGS. 15 and 16. The bracket 28, similar to the bracket 141, can be welded or bolted using bolt holes 28a to the frame of the trailer. The locking shaft 140 then slides in place inside the bracket 28 where it is locked in place via locking holes 28b and any of the locks or locking pins described herein or otherwise.

Referring now to FIGS. 2, 2A, and 3, in operation the support bracket 20 is placed onto or over a part of the rail of the trailer 10. The mounting brace 30 is then slid through one of the slots 23 of the support bracket 20; preferably the slot 23 nearest the railing member of the trailer 10 is used to reduce the “play” between the rail and the locking system 5. The locking shaft 40 is then dropped through the shaft hole 25 of the support bracket 20 and the plate hole 35 of the mounting brace 30. The trailer 10 is then raised to the level the user feels will adequately secure the trailer 10 and the locking pin 50 is then inserted through the appropriate locking slot 48 in the locking shaft 40 to secure the locking shaft 40, and thereby the trailer, at that height desired. A lock of the user's choice is then inserted through the lock hole 55 and locked in order to complete installation and thus securing of the locking system 5 to the trailer 10. The locking shaft 40 of this and previous embodiments can be formed by extruding the elongated shape and then cutting or otherwise forming it to the proper length. The holes or slots formed in the locking shaft 40 can be formed either during the extrusion process or afterwards. Similarly, the support brace 141 of the embodiment illustrated in FIGS. 15 and 16 can be cut from extruded forms thereby reducing the overall cost of manufacturing.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A trailer locking system for a trailer, comprising:
a vertical shaft;
a locking bracket; and
a lock adapted to engage the vertical shaft and the locking bracket;
wherein the locking bracket and lock are adapted to engage the locking shaft to affix the locking shaft to the trailer at a vertical height that renders the trailer harder to tow.

2. The trailer locking system of claim 1, wherein the vertical shaft comprises at least one locking hole.

3. The trailer locking system of claim 2, wherein the vertical shaft further comprises a plurality of locking holes adapted to correspond to different locking heights of the trailer.

4. The trailer locking system of claim 2, wherein the locking bracket further comprises an L-shaped support bracket and a mounting brace.

5. The trailer locking system of claim 4, wherein the locking bracket further comprises a first side and a second side, the first side comprising a plurality of slots and the second side comprising a hole adapted to accept the vertical shaft.

6. The trailer locking system of claim 5, wherein the mounting brace is a substantially flat plate having a hole formed therein and having at least one retaining tab formed on one side.

7. The trailer locking system of claim 6, wherein the hole formed in the mounting brace corresponds substantially to the hole of the second side of the support bracket.

8. The trailer locking system of claim 7, wherein the lock further comprises a flat elongated locking pin having a retaining tab at one end and a locking hole at the other.

9. The trailer locking system of claim 8, wherein the locking shaft further comprises a square tube extension portion and an elongated flat strip portion.

10. The trailer locking system of claim 1, wherein the lock further comprises a locking pin and a receiver lock.

11. A locking mechanism for a trailer comprising:
a retaining bracket attached to the trailer, thereby forming a substantially vertical opening; and a locking shaft adapted to fit in the opening formed by the bracket and the trailer; wherein the bracket and the locking shaft each have holes formed therein to accept a lock to affix the locking shaft within the opening.

12. The locking mechanism of claim 11, wherein the mounting brace is substantially U-shaped and the locking shaft is substantially an elongated square tube.

13. The locking mechanism of claim 12, wherein the lock consists of a locking pin and a receiving lock.

14. A method for preventing the theft of a trailer having a towing hitch and frame, the method comprising the steps of: attaching a bracket to the frame; inserting a locking shaft through a substantially hole in the bracket; and locking the locking shaft to the bracket such that the locking shaft cannot move vertically with respect to the bracket.

15. The method of claim 14, wherein the attaching step further comprises welding the bracket to the frame.

16. The method of claim 15, wherein the locking step is performed using a receiving lock.

17. The method of claim 14, further comprising the step of forming a bracket from a first L-shaped locking bracket and a mounting brace.

18. The method of claim 14, further comprising the step of forming a bracket by extruding a length of substantially U-shaped metal and then forming a hole in each of the opposing extruded sides of the extruded metal.
